(19) United States
(12) Patent Application Publication
(10) Pub. No.: US 2007/0214090 A1
(43) Pub. Date: Sep. 13, 2007

(54) Digital data processing apparatus and method, data reproducing terminal apparatus, data processing terminal apparatus, and terminal apparatus

(75) Inventors: Yoichiro Sako, Tokyo (JP); Tatsuya Inokuchi, Kanagawa (JP); Kaoru Kijima, Tokyo (JP); Junichi Kudo, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation

(21) Appl. No.: 11/714,353

(22) Filed: Mar. 6, 2007

Related U.S. Application Data
(62) Division of application No. 09/914,309, filed on Aug. 24, 2001.

(30) Foreign Application Priority Data
Dec. 28, 1999 (JP) 374231/1999
Dec. 28, 1999 (JP) 375336/1999

(51) Int. Cl. G06Q 99/00

(52) U.S. Cl. 705/52; 705/51

(57) ABSTRACT

A digital data processing apparatus which receives digital data whose use is charged for through a data recording medium or a network and uses the received digital data by using use right data, wherein the apparatus has memory means in which use history information of the digital data has been stored, and an accumulation of uses of the digital data is monitored by use history information, and when the accumulation of the uses reaches a preset value, a transfer of the use history information is promoted.

### CROSS REFERENCE TO RELATED APPLICATIONS

This application is a divisional of U.S. application Ser. No. 09/914,309, filed on Aug. 24, 2001, which is a U.S. National Stage Application of Application No. PCT/JP00/09180, filed Dec. 25, 2000, which claims priority from Japanese Patent Application Nos. JP 374231/1999 filed on Dec. 28, 1999 and JP 375336/1999 filed on Dec. 28, 1999.

### TECHNICAL FIELD

The invention relates to a digital data processing apparatus and its method, a data reproducing terminal apparatus, a data processing terminal apparatus, and a terminal apparatus which are applied to, for example, music distribution.

### BACKGROUND ART

In a compact disc (CD), a DVD (Digital Versatile Disc or Digital Video Disc), and the like, for the purpose of protecting a copyright, various copy preventing techniques for preventing an illegal copy have been proposed and put into practical use. For example, according to the SCMS (Serial Copy Management System), although a copy of the first generation from a CD to an MD (Mini Disc: registered trademark) is permitted, a copy from an MD to another medium, that is, a copy of the second generation when seen from a CD is inhibited. A system for copy generation limitation for limiting the generation number of a copy of data such as music or the like which can be formed from a signal source serving as a parent is also known.

In recent years, under rapid development of the network as well as the Internet, music contents is being circulated through the network. In such a situation, the EMD (Electronic Music Distribution) using the network such as Internet, satellite broadcast, or the like has been started and a method of managing the copyrights in the EMD has been proposed. In the EMD, the user can obtain music contents by paying compensation, that is, by being charged for. Also in the EMD, to prevent an illegal copy, the technique such as SCMS, copy generation limitation, or the like as mentioned above is being used.

As mentioned above, according to the conventional copyright protecting method, since the copy is limited by using the copy preventing technique and the right of a copyrighter is protected, such a method becomes an obstacle to a purpose for widely circulating the music contents in a short time. For example, there is an assessment system as one of the conventional copyright protecting systems. The assessment system has been enforced in a DAT (Digital Audio Taperecorder) and an MD, and the user of a digital recording apparatus pays compensation added to a price of a product. Now that the network has been developed and the contents distributed through the network is received and reproduced by a personal computer, in many cases, hardware (player, media) and the contents do not correspond to each other in a one-to-one relational manner. Such an assessment system is improper as a system for copyright protection.

In the case where a plurality of music pieces have been recorded in a media, for example, a CD, there is a case where the user wants to listen only to a specific one or some of the music pieces and there is also a case where the user does not want to purchase the whole media, in this case, one CD. Further, advertisement and circulation of the music contents are obstructed by the copy preventing techniques. Rather, if the music contents is distributed free of charge, the music contents can be advertised and circulated in a short time and the costs for the advertisement and circulation can be also reduced. Therefore, to enable the contents to be easily and promptly circulated and enable the copyrighter to obtain the legal consideration, a system such that although the distribution itself is executed free of charge, a charging process is performed upon decoding, reproduction, or getting the contents is considered.

In such a system, a process such that use history information, for example, reproduction history information of contents is uploaded from a terminal on the user side to a management organization or a management center which distributes the music contents is effective for improvement of a taste of the user or a security of the contents. However, since it is impossible to store the reproduction history information without any restriction, it is necessary to transfer the reproduction history information before a memory in which the reproduction history information has been stored overflows. If the user forgets to transfer the reproduction history information to the management center or the like, there is a risk that the memory overflows and the correct reproduction history information cannot be transferred.

It is, therefore, an object of the invention to provide a digital data processing apparatus and its method, a data reproducing terminal apparatus, a data processing terminal apparatus, and a terminal apparatus, which can certainly transfer use history information.

In the system as mentioned above, not only the contents as a charge target is always distributed, and a case where the contents to be charged for and the contents which is not charged for exist mixedly on the same data recording medium or communicating medium occurs. As contents which is not charged for, contents which is inherently free as a prerequisite and contents whose fee has already been paid when the data recording medium is purchased or when the contents is purchased through the communicating medium are included. Generally, an apparatus for reproducing the obtained contents is also used in common for both contents which is charged for and contents which is not charged for. Therefore, there is a fear of occurrence of a problem such that the user unconsciously reproduces the contents to be charged for. In the case where the user downloads the contents to his own personal computer through the communicating medium, a problem such that a capacity of the memory is reduced due to the downloading of the contents which the user does not want to reproduce.

It is, therefore, an object of the invention to provide a digital data processing apparatus and its method, a data reproducing terminal apparatus, a data processing terminal apparatus, and a terminal apparatus, which can prevent contents to be charged for from being reproduced against his will by notifying of whether contents to be reproduced is contents which is charged for or contents which is free.

### DISCLOSURE OF INVENTION

According to the invention of claim 1, there is provided a digital data processing apparatus for receiving digital data whose use is charged for through a data recording medium or a network and using the received digital data by using use right data, comprising

memory means in which use history information of the digital data has been stored,

wherein an accumulation of uses of the digital data is monitored by the use history information and, when the accumulation of the uses reaches a preset value, a transfer of the use history information is promoted.

According to the invention of claim 4, there is provided a digital data processing apparatus for receiving digital data whose use is charged for through a data recording medium or a network and using the received digital data by using use right data, comprising:

memory means in which use history information of the digital data has been stored; and

communicating means for communicating with a settlement center,

wherein an accumulation of uses of the digital data is monitored by the use history information and, when the accumulation of the uses reaches a preset value, the use history information is automatically transferred to the settlement center through the communicating means.

According to the invention of claim 6, there is provided a digital data processing apparatus for receiving digital data whose use is charged for through a data recording medium or a network and using the received digital data by using use right data, comprising

memory means in which use history information of the digital data has been stored,

wherein a transfer of the use history information is promoted when a preset date comes.

According to the invention of claim 8, there is provided a digital data processing apparatus for receiving digital data whose use is charged for through a data recording medium or a network and using the received digital data by using use right data, comprising:

memory means in which use history information of the digital data has been stored; and

communicating means for communicating with a settlement center,

wherein the use history information is automatically transferred through the communicating means to the settlement center when a preset date comes.

According to the invention of claim 9, there is provided a digital data processing apparatus for receiving digital data whose use is charged for through a data memory medium or a network and using the received digital data by using use right data, comprising:

memory means in which use history information of the digital data has been stored; and

display means for displaying a use fee of a capacity of the memory means or a remaining amount of the capacity.

According to the invention of claim 11, there is provided a digital data processing apparatus for receiving digital data whose use is charged for through a data memory medium or a network, comprising

memory means in which use history information of the digital data has been stored,

wherein an accumulation of uses of the digital data is monitored by the use history information and the use of the digital data is inhibited when the accumulation of the uses reaches a preset value.

According to the invention of claim 13, there is provided a digital data processing method which is used for a medium or a network in which first digital data whose decoding or reproduction is charged for and second digital data whose decoding or reproduction is free exist mixedly, comprising the steps of:

when distributed digital data is decoded, reproduced, or obtained, discriminating whether the distributed digital data is the first or second digital data; and

when it is determined that the distributed digital data is the first digital data, displaying or notifying of a fact that the decoding or reproduction is charged for.

According to the invention of claim 20, there is provided a digital data processing method which is used for a medium or a network in which first digital data whose signal or reproduction is charged for and second digital data whose decoding or reproduction is free exist mixedly, comprising the steps of:

when distributed digital data is decoded, reproduced, or obtained, discriminating whether the distributed digital data is the first or second digital data; and

when it is determined that the distributed digital data is the first digital data, inhibiting the decoding, reproduction, or obtaining of the first digital data.

According to the invention of claim 27, there is provided a digital data processing method which is used for a medium or a network in which first digital data whose decoding or reproduction is charged for and second digital data whose decoding or reproduction is free exist mixedly, comprising the steps of:

when distributed digital data is decoded, reproduced, or obtained, discriminating whether the distributed digital data is the first or second digital data; and

when it is determined that the distributed digital data is the first digital data, displaying or notifying of a fact that the decoding or reproduction is charged for and inhibiting the decoding, reproduction, or obtaining of the first digital data.

According to the invention of claim 34, there is provided a digital data processing apparatus which is used for a medium or a network in which first digital data whose decoding or reproduction is charged for and second digital data whose distribution is charged for and whose decoding or reproduction is free exist mixedly, comprising:

means for, when distributed digital data is decoded, reproduced, or obtained, discriminating whether the distributed digital data is the first or second digital data; and

means for, when it is determined that the distributed digital data is the first digital data, displaying or notifying of a fact that the decoding or reproduction is charged for.

According to the invention of claim 35, there is provided a digital data processing apparatus which is used for a medium or a network in which first digital data whose decoding or reproduction is charged for and second digital data whose decoding or reproduction is free exist mixedly, comprising:

means for, when distributed digital data is decoded, reproduced, or obtained, discriminating whether the distributed digital data is the first or second digital data; and

means for, when it is determined that the distributed digital data is the first digital data, inhibiting the decoding, reproduction, or obtaining of the first digital data.

According to the invention of claim 38, there is provided a digital data processing apparatus which is used for a medium or a network in which first digital data whose decoding or reproduction is charged for and second digital data whose decoding or reproduction is free exist mixedly, comprising:

means for, when distributed digital data is decoded, reproduced, or obtained, discriminating whether the distributed digital data is the first or second digital data; and

means for, when it is determined that the distributed digital data is the first digital data, displaying or notifying of a fact that the decoding or reproduction is charged for and inhibiting the decoding, reproduction, or obtaining of the first digital data.

According to the invention of claim 41, there is provided a data reproducing terminal apparatus comprising:

a signal processing unit for performing a signal process necessary for reproduction to contents data read out from a medium in which a plurality of contents data to which an encrypting process and/or a compressing process have/has been executed is recorded;

a memory unit in which reproduction history data of the contents data to which the process has been performed by the signal processing unit is written; and

a control unit for promoting a transfer of the reproduction history data stored in the memory unit to an outside when the reproduction history data written in the memory unit reaches a predetermined value.

According to the invention of claim 45, there is provided a data processing terminal apparatus comprising:

a memory unit in which reproduction history data transferred from a reproducing unit for performing a reproducing process of contents data read out from a medium in which a plurality of contents data to which an encrypting process and/or a compressing process have/has been executed is recorded is written; and

a control unit for promoting a transfer of the reproduction history data stored in the memory unit to an outside when the reproduction history data written in the memory unit reaches a predetermined value.

According to the invention of claim 53, there is provided a data reproducing terminal apparatus comprising:

a signal processing unit for performing a signal process necessary for reproduction to contents data read out from a medium in which a plurality of contents data to which an encrypting process and/or a compressing process have/has been executed and subordinate data associated with each of the contents data are recorded;

notifying means for notifying of whether the contents data read out from the medium needs a charging process upon reproduction or not; and

a control unit for discriminating whether the charging process is necessary or not upon reproduction of the contents data read out from the medium when the signal process is executed by the signal processing unit and driving the notifying means when the charging process is necessary upon reproduction of the contents data read out from the medium as a result of the discrimination.

According to the invention of claim 61, there is provided a terminal apparatus comprising:

a memory unit in which a plurality of downloaded contents data to which an encrypting process and/or a compressing process have/has been executed and subordinate data associated with each of the contents data are stored;

a signal processing unit for performing a signal process necessary for reproduction to the contents data read out from the memory unit;

notifying means for notifying of whether the contents data read out from the memory unit needs a charging process upon reproduction or not; and

a control unit for discriminating whether the contents data read out from the memory unit needs the charging process upon reproduction or not when the signal process is executed by the signal processing unit and driving the notifying means when the charging process is necessary upon reproduction of the contents data read out from the memory unit as a result of the discrimination.

### BRIEF DESCRIPTION OF DRAWINGS

FIG. 1 is a block diagram showing an outline of a whole system according to an embodiment of the invention.

FIG. 2 is a block diagram for explanation regarding listening right data in the embodiment of the invention.

FIG. 3 is a block diagram for explanation regarding a listening right data charger in the embodiment of the invention.

FIG. 4 is a block diagram for explanation regarding the listening right data in the embodiment of the invention.

FIG. 5 is a block diagram for explanation regarding a function which is fulfilled by a settlement center in the embodiment of the invention.

FIG. 6 is a block diagram of an example of a player in the embodiment of the invention.

FIG. 7 is a flowchart for explaining an example of a charging process in the embodiment of the invention.

FIG. 8 is a block diagram of an example of the listening right data charger in the embodiment of the invention.

FIG. 9 is a schematic diagram for explaining a demand for transfer of reproduction log in the listening right data charger and a remaining amount or a use amount of a memory capacity in the embodiment of the invention.

FIG. 10 is a more detailed block diagram of a secure decoder in the embodiment of the invention.

FIG. 11 is a schematic diagram showing a data configuration in the embodiment of the invention.

FIG. 12 is a flowchart for explaining an example of processes in another embodiment of the invention.

FIG. 13 is a schematic diagram for explaining an example in which the invention is applied to a portable player.

FIG. 14 is a schematic diagram for explaining an example in which the invention is applied to a case of selectively downloading a music piece.

FIG. 15 is a schematic diagram for explaining an example in which the invention is applied to a cellular phone.

### BEST MODE FOR CARRYING OUT THE INVENTION

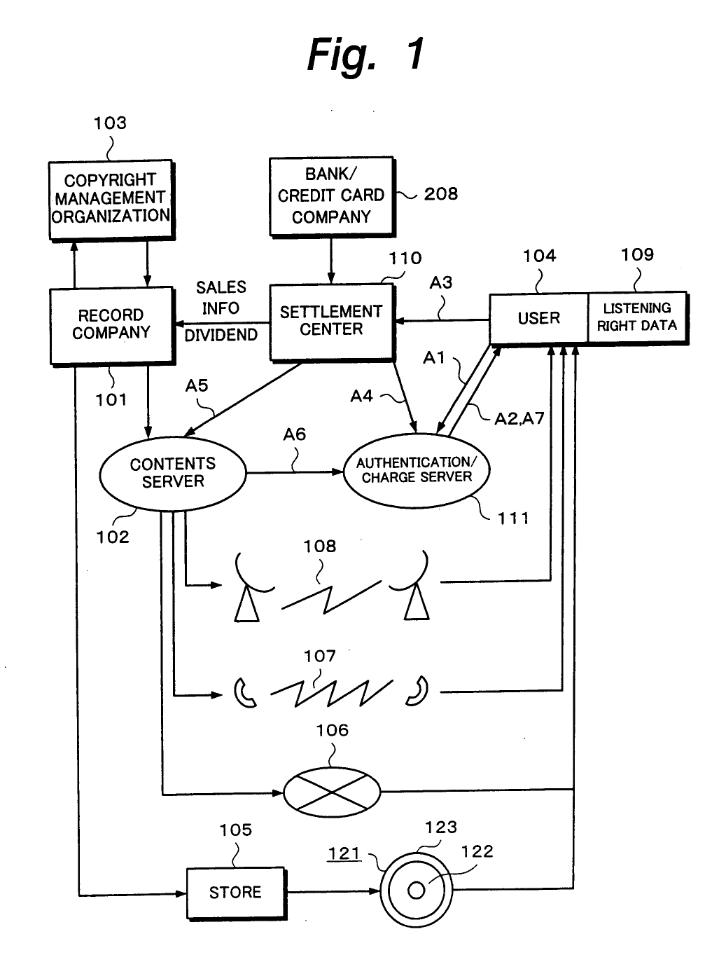

An embodiment in which the invention is applied to a music distribution system EMD (Electronic Music Distribution) will now be described hereinbelow. An outline of the music distribution system will be first described with reference to FIG. 1. In FIG. 1, reference numeral 101 denotes a music contents distribution provider, for example, a record company, and 102 indicates a contents server. The record company 101 produces music contents and distributes them. The record company 101 also performs a compression encoding, an encryption, and an embedding of a watermark with respect to the music contents. Contents produced by the record company 101 is accumulated into the contents server 102.

Reference numeral 103 denotes a copyright management organization. For example, JASRAC (Japanese Society for the Rights of Authors, Composers, and Publishers) is a specific example of the copyright management organization 102. The record company 101 receives permission of a copy or the like from the copyright management organization 103 and pays a copyright fee to the copyright management organization 103.

Reference numeral 104 denotes a user device having a reproducing function of the distributed music contents. The user device 104 has functions for receiving the distributed music contents, reproducing the received contents, and executing a reproduction charging process. That is, the user device 104 decodes the encryption performed to the data of the received music contents and decodes the compression encoding performed to the data, so that it can reproduce the distributed music contents. The charging process is executed to the decoding of the contents data. A contents distribution provider exists as necessary between the contents server 102 and user device 104 and distributes contents requested from the user side among the contents in the contents server 102 to the user. Several means exist as distributing means which is used by the distribution provider. One of them is a store 105. For example, as a supplement of a magazine which is sold at the store 10, a media in which contents has been recorded is distributed to the user. As another means, a wire network 106 like Internet or CATV (cable television) is used as distributing means of the contents. Further, a cellular phone network 107 and a satellite network 108 such as satellite broadcast, satellite communication, or the like is used as distributing means of the contents.

In the invention, it is not obstructed to use distributing means of contents which is distributed with charge as contents distributing means mentioned above. In case of, for example, a CD (Compact Disc: CD, registered trademark) as a medium, a copyright fee for recorded music piece is included in the price of the CD. It is also possible to distribute free of charge and record contents which is charged for for decoding (reproduction) into another area different from an area in which toll contents on the CD has been recorded.

In FIG. 1, an extended CD 121 as one of the media which are delivered to the user by being sold by the store 105 is shown. An area 122 on the inner rim side of the extended CD 121 is an area which has the same format as that of the existing CD and in which music piece data as contents data whose distribution is charged for and whose reproduction is free, that is, a non-compression linear PCM signal has been recorded. An area 123 on the outer rim side of the extended CD 121 is an area in which contents data whose distribution is free and whose reproduction is charged for has been recorded. Since the contents data has been compression encoded, music data of at least a necessary length, for example, data of the time almost equal to that of the music piece data recorded in the area 122 in a decompressed state can be recorded into the area 123.

Also in case of a medium such as MD, memory card, or the like other than the CD, an area in which contents data whose distribution is charged for and whose reproduction is free is stored and an area in which contents data whose distribution is free and whose reproduction is charged for is stored are provided as areas which can be distinguished from each other, and data can be recorded in a manner similar to that of the extended CD 121 mentioned above. Contents whose distribution is free and whose reproduction is charged for can be also distributed as a service for distributing music contents by using the satellite television broadcast.

The user device 104 can receive the distributed contents data free of charge. The received contents data can be also freely redistributed from the user device 104 by the will of the user. “Free” used here denotes that the fees do not include the actual expenses such as communication fee, charge for electricity, and the like but are free with respect to a copyright fee. When the contents data received by the user device 104 is reproduced, more specifically speaking, when the encryption performed to the contents data is decoded, a charging process is executed. Listening right data 109 is used for the charging process. The listening right data 109 has been stored in an IC card or a memory in a secure decoder. The listening right data 109 can be rewritten by a charger which the user possesses or by a sales terminal installed in the nearest store under the management of a listening right data management company, as electronic money or an electronic use right. The listening right data 109 is, for example, a degree at which the data can be reproduced. Each time the user device 104 reproduces the contents as a target to be charged for, for example, the degree is subtracted.

Although the listening right data 109 will be explained as an example hereinbelow, what is called electronic money can be also used for payment of reproduction of the contents. Further, a multipurpose IC card which can handle electronic money, listening right data, and the like in a lump can be also used as foregoing listening right data.

A settlement center 110 exists for the purpose of making a cost settlement in association with the record company 101, copyright management organization 103, and user device 104. The settlement center 110 has an authentication/charge server 111. The settlement center 110 makes a cost settlement with a bank/credit card company 208.

When the user device 104 requests listening right data in order to reproduce the received contents, the authentication/charge server 111 is requested to authenticate the user device 104 (shown by a path A1). When the user device 104 is determined to be legal and the authentication of the user device 104 is satisfied, the authentication/charge server 111 requests a charge from the user device 104 (path A2). The user device 104 makes a cost settlement corresponding to the charging request with the settlement center 110 (path A3).

The settlement center 110 notifies the authentication/charge server 111 of a fact that the charge has been performed by the user or by the user device 104 or the charging process can be performed as shown by a path A4, and requests the contents server 102 to transmit key data information of the contents (path A5). The contents server 102 supplies key data serving as a master for decoding the encryption performed to the contents data to the authentication/charge server 111 (path A6). The authentication/charge server 111 sends the key data to the user device 104 together with the listening right data (path A7). On the basis of the key data, the user device 104 decodes the encryption performed to the contents data and can reproduce the contents data. When the contents data is decoded, it is decided that the contents has been reproduced. The degree of the listening right data 109 is decreased by, for example, “1”. When the degree of the listening right data 109 reaches “0”, the user device 109 cannot decode the contents data. The case where the key data serving as a master is transferred together with the listening right data is shown in FIG. 1. As another method, it is also possible to use a method whereby the fixed key data is preliminarily stored upon manufacturing of the user device, a method whereby the key data is embedded into the contents by encoding whose decoding is difficult and the key data is transferred together with the contents, or a method of a combination of them.

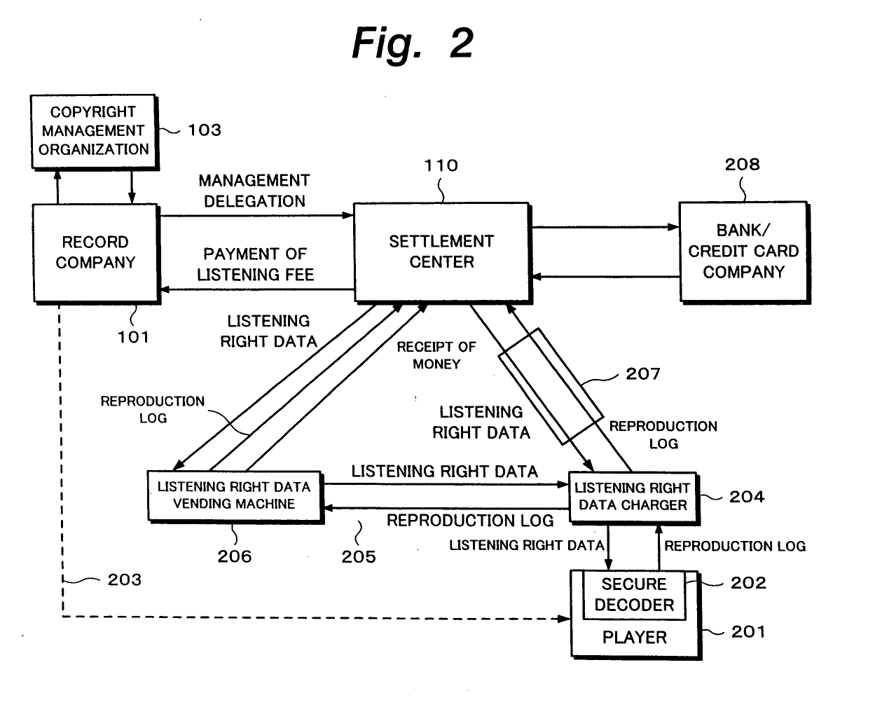

FIG. 2 shows an example of a system regarding the listening right data 109, and the delivery of the music contents and the transmission and reception of the data for decoding the encryption of the contents are omitted. A player 201 is shown as a device corresponding to the user device 104. The player 201 has therein a secure decoder 202. The player 201 is, for example, a portable audio apparatus. In FIG. 2, as shown by a broken line, contents data of music contents has been recorded and stored in a medium (optical disc, memory card, etc.) which is reproduced by the player 201. As a method of distributing the music contents, various methods can be used as shown in FIG. 1.

Reference numeral 204 denotes a listening right data charger as a user terminal. The data charger 204 exists between the secure decoder 202 of the player 201 and the settlement center 110 or a data sales terminal 206 installed in a record shop, a convenience store, or the like and functions as a listening right data relay.

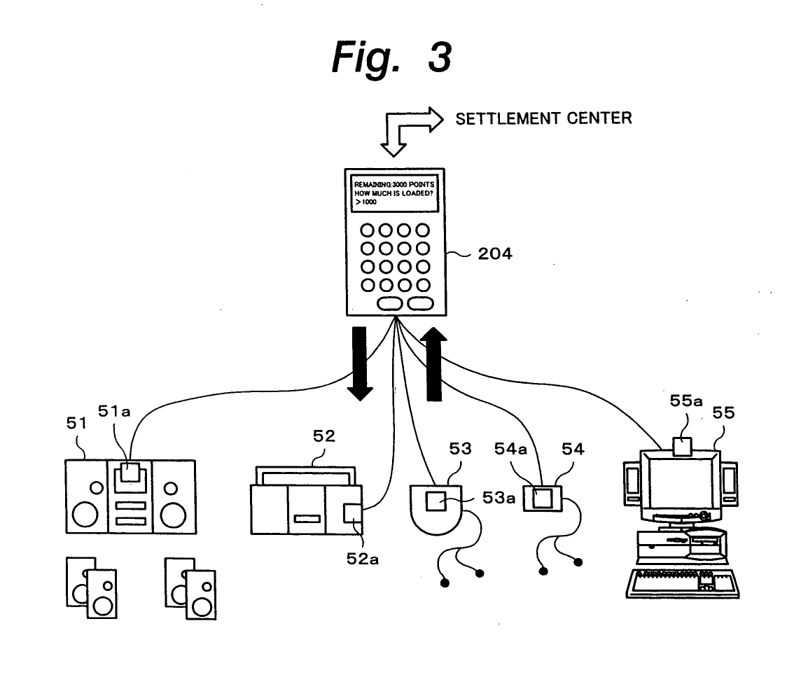

FIG. 3 schematically shows functions of the data charger 204. In FIG. 3, a specific example of the player 201 having a possibility that it is installed in a home. Reference numeral 51 denotes an audio reproducing system in which an amplifier and speakers are separated; 52 a reproducing apparatus in which a tuner and a CD player (or MD (Mini Disc: registered trademark) recorder) are integrated; 53 a portable CD player; 54 a portable MD player; and 55 a personal computer. Those players are equipped with secure decoders 51a, 52a, 53a, 54a, and 55a each having an IC construction. The data charger 204 is shared by those players and a transmission of the listening right data 109 to a player as a user device and an extraction of reproduction history information from the player side can be performed by a dedicated connecting line, a contactless radio communication, a USB (Universal Serial Bus), or an IEEE (Institute of Electrical and Electronics Engineers) 1394. The data charger 204 has a portable structure.

The secure decoder 202 in the player 201 and the data charger 204 communicate through a wire or radio communication path. The listening right data 109 is transferred from the data charger 204 to the memory in the secure decoder 202. The listening right data 109 corresponds to information indicative of the number of reproduction possible times, for example, the foregoing degree or a reproduction possible time of the player 201.

The reproduction history information (reproduction log) of the player 201 is transmitted from the player 201 to the data charger 204 through a wire or radio communication path 205. The reproduction log includes an identifier of the digital data as contents data decoded by the player 201 and/or decoding conditions. Specifically speaking, the reproduction log includes information of the kind of listened music contents, the number of reproducing times, reproducing time, and the like. The reproduction log includes an identifier for specifying a charge target person such as holder of the player as a user device, identifier of the player as a user device, or the like. The secure decoder 202 and data charger 204 make an authentication as necessary. When the authentication is satisfied, the encrypted listening right data and the reproduction log are transmitted between the secure decoder 202 and data charger 204.

The listening right data 109 is sent from the settlement center 110 to the data charger 204 through a communication path 207, for example, a telephone line, or the listening right data 109 sent from the settlement center 110 to the sales terminal 206 through a communication path 209 is supplied to the data charger 204 through the communication path 205. Also in this case, the authentication and encryption are performed for the purpose of assuring the security.

The reproduction log extracted from the player 201 to the data charger 204 is sent to the settlement center 110 through the communication path 207 or supplied to the sales terminal 206 through the communication path 205. When the listening right data 109 is received from the settlement center 110 through the communication path 209, the sales terminal 206 sends the reproduction log transmitted from the data charger 204 to the settlement center 110. The sales terminal 206 pays the costs of the obtained listening right data to the settlement center 110. The communication path 209 is, for example, the telephone line, Internet, or the like.

The listening right data 109 and the reproduction log are transmitted and received between the settlement center 110 and the data charger 204 through the communication path 207. Also in this case, the transmission and reception by the authentication and the encryption are performed between the settlement center 110 and the data charger 204 for the purpose of assuring the security. The bank/credit card company 208 exists with regard to the settlement of the listening right data 109. On the basis of a request from the settlement center 110, the bank/credit card company 208 withdraws an amount of money corresponding to the listening right data 109 written into the data charger 204 from the user's bank account which has previously been registered.

The settlement center 110 receives delegation of management of services regarding the listening right data 109 from the record company 101. The settlement center 110 provides techniques regarding the listening right data 109 to the record company 101 and, further, pays a music piece listening fee. As described with reference to FIG. 1, the record company 101 pays a copyright fee to the copyright management organization 103 in accordance with the use of the copyright.

Although not shown in FIG. 2, the data charger 204 can transfer, add, or divide a part or all of the listening right data to/from another data charger through a communicating apparatus, for example, a contactless communicating apparatus. The data charger 204 can transfer the listening right data 109 to a prepaid card having a construction of an IC card for the charging process besides the secure decoder 202 of the player 201.

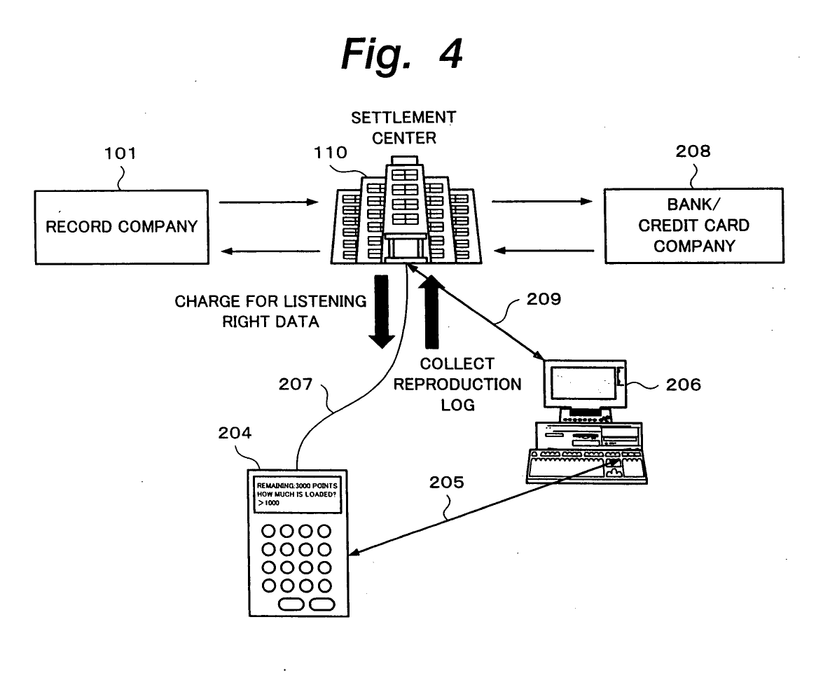

FIG. 4 shows a mutual relation among the record company 101, settlement center 110, data charger 204, listening right data sales terminal 206, and bank/credit card company 208 in the charge processing system shown in FIG. 2. The settlement center 110 has functions for selling the listening right data between the center and the charger 204 and sales terminal 206, collecting the reproduction logs from the charger 204 and terminal 206, and making a settlement of the costs on the basis of the sold listening right data.

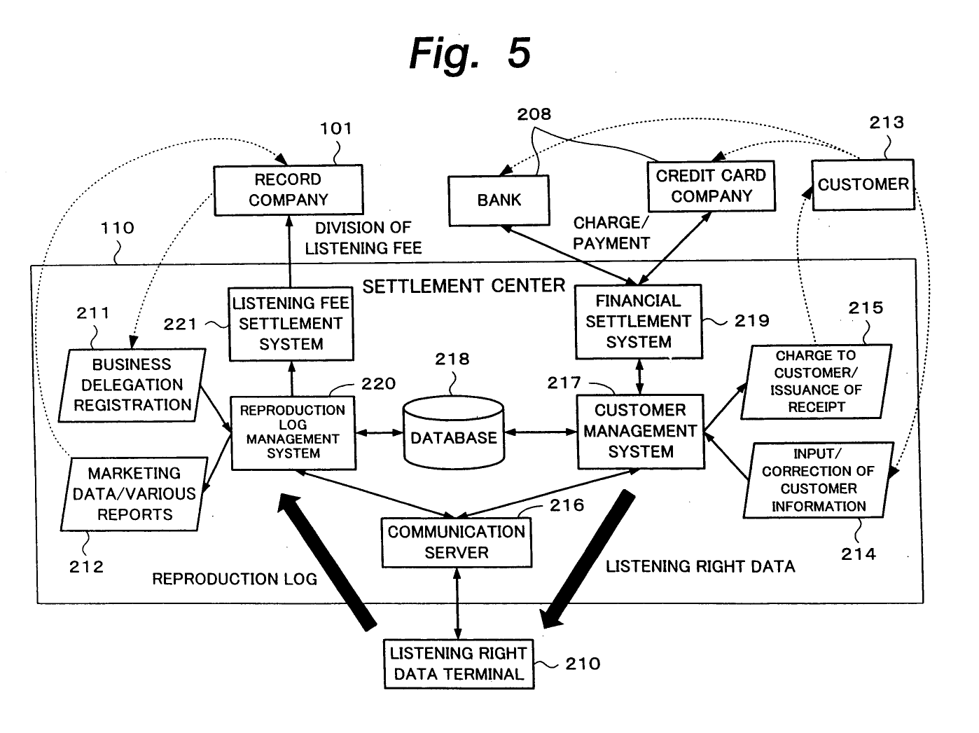

FIG. 5 shows in more details the functions of the settlement center 110 connected to a listening right data terminal 210 (data charger 204 or sales terminal 206). In FIG. 5, paths shown by solid lines denote processes which are necessary when the charging process is executed and paths shown by broken lines denote processes which are necessary as a preparation to execute the charging process. In many cases, the processes of the paths shown by the broken lines are executed by mail (transmission and reception of a document) and the processes of the paths shown by the solid lines are executed by using data communication using a communication network.

The processes by the paths of the broken lines will be first described. Between the record company 101 and settlement center 110, the record company 101 performs a business delegation registration to the settlement center 110 (block 211). The settlement center 110 sends marketing data to the record company 110 and issues various reports (block 212).

A customer 213 as a holder of the data charger 204 makes a contract such as payment of the fee, withdrawal of the fee from the account, and the like with the bank/credit card company 208. The customer 213 reports a change or the like of the contents of the contract to the settlement center 110, and the settlement center 110 inputs or corrects customer information (block 214). The settlement center 110 issues and mails a bill and a receipt to the customer 213 (block 215).

Processes by the paths of the solid lines will be subsequently explained. The settlement center 110 sends the listening right data 109 to the data terminal 210 in response to a request from the customer. In this case, the settlement center 110 specifies the customer and sends data to which the authenticating and encrypting processes have been performed through a communication server 216 to the terminal 210. A customer management system 217 specifies the authenticated customer with reference to the customer information in a database 218. On the basis of an amount of transferred listening right data 109, the system 217 requests a financial settlement system 219 to withdraw the fee. The financial settlement system 219 requests the bank/credit card company 208 to pay the fee from the customer's account, so that payment of the fee is executed from the account of the customer, that is, the user. When the settlement center 110 receives a report indicative of the completion of the payment from the bank/credit card company 208, the settlement center 110 issues a receipt to the customer.

The terminal 210 is authenticated before the settlement center 110 transfers the listening right data 109 to the data terminal 210. The settlement center 110 receives the reproduction log from the data terminal 210 through the communication server 216. The encryption performed to the received reproduction log is decoded by the communication server 216 and the decoded reproduction log is sent to a reproduction log management system 220. The reproduction log includes: a terminal identifier to specify the customer (data terminal 210); an identifier to specify the decoded and reproduced music contents; and data of the number of listening times of each music contents, its time, and its period. The terminal identifier to specify the customer is mainly used for transferring the listening right data from the settlement center 110 to the terminal 210 as mentioned above or used for the charging to the user's account.

The reproduction log management system 220 once stores the reproduction log into the database 218 and sends the reproduction log or the data obtained by processing the reproduction log by a batch process to a listening fee settlement system 221 at a predetermined timing, for example, every month. The listening fee settlement system 221 calculates a listening fee (copyright use fee) of each music piece on the basis of the data regarding the received reproduction log with reference to information of the music piece or the like registered in the database 218 when the business is delegated from the record company 101. It is also possible to calculate the listening fee every item such as composer, song writer, singer, player, or the like other than the music piece. The listening fee of each music piece calculated by the listening fee settlement system 221 is paid to the record company 101.

As mentioned above, the settlement center 110 transfers the listening right data 109 to the customer 213 and requests the listening fee from the customer 213. On the other hand, the settlement center 110 executes processes for calculating and distributing the listening fee of each music piece as mentioned above. Therefore, it is unnecessary that the record company 101 executes operations for performing a customer management and calculating and distributing the listening fee. Since the settlement center 110 is an organization which is independent of the record company 101, contracts of business delegation can be made with a plurality of record companies, and the number of kinds of music contents which can be selected by the customer can be increased by a method whereby a plurality of record companies join.

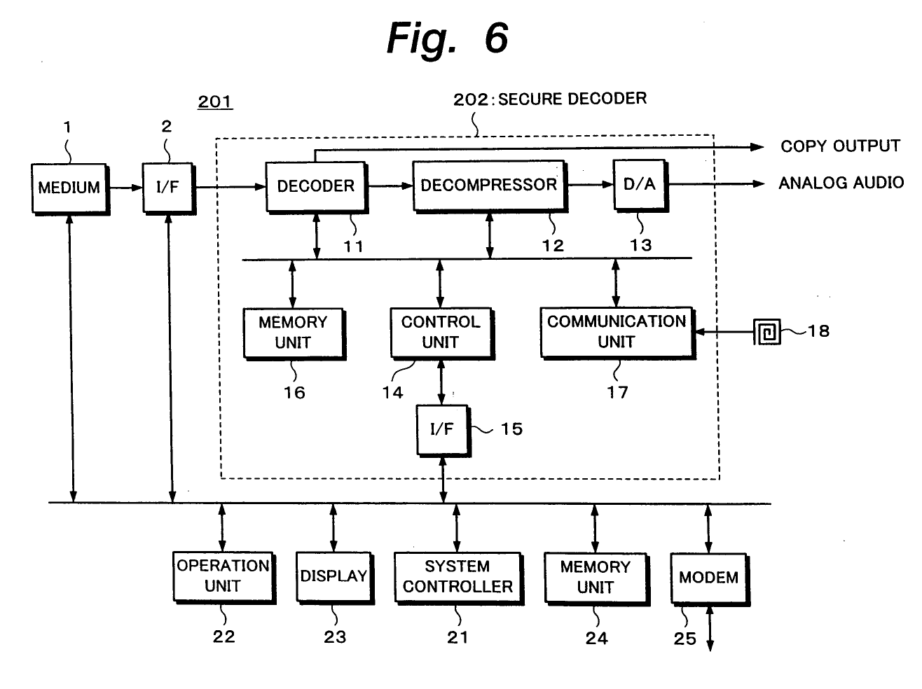

FIG. 6 shows a construction of a signal processing unit of the player 201 as a user terminal 210 having the secure decoder 202. The secure decoder 201 is constructed as an IC of one chip as shown by a broken line. The secure decoder 201 has what is called a tamper-resistant construction. That is, the secure decoder 202 has a construction such that the contents in the decoder 202 cannot be known from the outside or the contents of the decoder 202 cannot be falsified.

The compression encoded or encrypted data, for example, music data has been recorded in a medium 1. Further, the compression encoded or encrypted data is associated with data necessary for the reproduction charging process. The compression encoded or encrypted data is referred to as contents data and the data for the reproduction charging process is referred to as subordinate data. In the invention, it is not always necessary that both of the compression encoding and encryption are performed. Even only by the compression encoding which is performed to the contents data, the purpose of protecting the copyright can be accomplished so long as its decoding method is not open to the public.

A memory card, a recordable optical disc, a read only optical disc, or the like can be used as a medium 1. In case of the recordable medium, as mentioned above, data distributed through a network such as satellite network, cellular phone network, Internet, or the like can be downloaded, that is, recorded or stored. The contents data and the subordinate data read out from the medium 1 are supplied to the secure decoder 202 through an interface 2. An analog audio signal based on the contents data read out from the medium 1 is outputted from the secure decoder 202. The analog audio signal outputted from the secure decoder 202 is reproduced by speakers, headphones, or the like (not shown) through an amplifier or the like (not shown).

The secure decoder 202 has a decoder 11 for decoding the encryption, a decompressor 12 for decoding the compression encoding, and a D/A converter 13. A DES (Data Encryption Standard) can be used as an encryption which is performed to the contents data. The DES is one of block encrypting methods for dividing a plane sentence into blocks and executing an encryption conversion every block. According to the DES, the encryption conversion of data is executed to an input of 64 bits by using a key of 64 bits (a key of 56 bits and a parity of 8 bits) and the encrypted data of 64 bits is outputted. An encryption other than the DES can be also used. For example, although the DES is based on a common key system using the same key data for encryption and decoding, it is also possible to use an RSA encryption as an example of a public key encryption using different key data for encryption and decoding. As mentioned above, the key data is sent to the user device 104, that is, the player 201 here from the server 111 in which the authentication has been satisfied.

The secure decoder 202 comprises: a control unit 14 including a CPU; a CPU interface 15 for performing communication between the control unit 14 and an external CPU; a memory unit 16; and a communication unit 17 and an antenna 18 for receiving the listening right data 109 from the data charger 204 and transmitting the reproduction log to the data charger 204. The control unit 14 receives the subordinate data separated from the data read out from the medium 1 at the front stage of the decoding in the decoder 11 and executes a control for executing processes for decoding and decompressing the subordinate data.

The communication unit 17 and antenna 18 are used for communicating with the listening right data charger 204 in a contactless manner. This communication is executed by using an encrypted protocol under a condition that the authentication is mutually made between the player 201, that is, the secure decoder 202 and charger 204. Since the player 201 can receive not only the data but also an electric power from the charger 204 through the communication unit 17 and antenna 18, even if a power source of the whole player 201 is OFF, the player 201 can receive the listening right data 109 from the charger 204 and transmit the reproduction log to the charger 204. The listening right data 109 received from the charger 204 is stored into the memory unit 16. Further, the reproduction log which is caused due to the reproduction of the contents which is executed by the player 201 is also stored into the memory unit 16. The memory unit 16 is a non-volatile memory whose storage contents are held even if a power source of the player 201 is turned off.

A copy output from the secure decoder 202 can be outputted from the decoder 11 to the outside of the secure decoder 202. Whether the copy output is outputted from the secure decoder 202 or not is controlled by the control unit 14. The copy output which is outputted from the secure decoder 202 is the subordinate data and the contents data. The decoder 11 and decompressor 12 have functions for omitting a decoding process and a decompressing process on the basis of an instruction from the control unit 14, respectively. Thus, the audio data which is not inherently encrypted or compression encoded, for example, a linear PCM signal can be reproduced.

A system controller shown at reference numeral 21 is provided to control the whole operation of the player 201. The system controller 21 is constructed by a CPU and controls the operation of the secure decoder 202 by communicating with the control unit 14 in the secure decoder 202. An operation unit 22, a display 23, a memory unit 24, and a modem 25 are connected to the system controller 21 through a bus. Further, the system controller 21 controls the reproducing operation of the medium 1 and the operation of the medium interface 2.

The operation unit 22 comprises a plurality of switches, keys, and the like which are operated by the user and generates the control signal for controlling the operation of the player 201 on the basis of the switch or key operated by the user. The display 23 is constructed by, for example, a liquid crystal display device and used for displaying a menu for allowing the user to control the operation of the player 201 and displaying an operating mode of the player 201. The memory unit 24 is an external memory provided because a capacity of a memory in the system controller 21 is small. The modem 25 is connected to a public line and used for data communication with an external apparatus. For example, by transferring the reproduction log in the memory unit 16 of the secure decoder 202 to the memory unit 24, the system controller 21 can display the remaining number of reproduction possible times or the reproduction possible time onto the display 23, or can transmit the reproduction log to an outside, for example, the settlement center 110 through the modem 25. Further, the listening right data 109 can be also received from the settlement center 110 through the modem 25. As mentioned above, the player itself can also have the function of the data charger.

The user operates the operation unit 22, thereby instructing the reproduction of desired contents recorded or stored in the medium 1. If the contents to be reproduced is free with respect to the reproduction, even if it is processed by the secure decoder 202 and outputted as an analog signal, the listening right data 109 stored in the memory unit 16 is not changed. If the reproduced contents is a target of the charge for the reproduction, the listening right data 109 in the memory unit 16 is changed.

As a charging process which is executed in the case where the contents to be reproduced or the reproduced contents is a target of the reproduction charge, various types are possible. The charging process is mainly classified into: a buying type; a type in which the monitoring fee is charged for in gross; and a degree type in which the monitoring fee is charged for each time the encryption is decoded in the secure decoder. The buying type is a type such that after the contents data is once bought, the reproducing process of the contents is not charged for, that is, the charging process does not occur. The type of grossly charging the monitoring fee is classified into a type of a monthly contract such that the monitoring fees are collectively paid, a type such that a monitoring period and a monitoring time are limited, and the like.

Several forms are possible as a degree type of charging the monitoring fee each time the encryption performed to the contents data is decoded by the secure decoder 202. According to the first form, each time the reproducing process of the contents is executed, a money amount or a degree is subtracted from a preset money amount (prepaid card, electronic money) or degree. If a balance of a preset money amount or a remaining degree lacks, the contents cannot be reproduced. According to the second form, a money amount or a degree is added each time the reproducing process of the contents is executed. When the accumulated money amount or accumulated degree reaches the money amount or degree which has been preset, the contents cannot be reproduced. According to the third form, the degree or money amount is added or subtracted in accordance with the reproducing time of the contents.

The money amount or degree which is added or subtracted to/from the preset money amount or degree which is used here can be made constant or the money amount or degree can be also weighted in accordance with the kind or the like of the contents to be reproduced. The charging process is performed in correspondence to one title of the contents (in an example of music; one music piece) or a plurality of titles of the contents (in an example of music; album).

As a method of defining the reproduction of the contents, in the case where the whole contents has been reproduced, it can be defined such that the contents was reproduced. In the case where the reproducing time of the contents is equal to or longer than a predetermined time, it can be also defined such that the contents was reproduced. The reproduction of the contents for promotion for promoting spread and circulation is not charged for. Even in case of contents whose reproduction becomes a charging target, for example, the reproduction of a head portion of the contents, for instance, 10 seconds from the head of the contents can be made free or the reproduction of only the highlight portion of the contents can be made free. As mentioned above, in the case where the contents whose reproducing process is charged for and the contents whose reproducing process is free exist mixedly, the “charge/free” is discriminated by the subordinate data.

As shown in FIG. 5, the subordinate data comprising a charge ID 131 and charge conditions information 132 is added before contents data (compression encoded and encrypted contents; for example, audio data) 133. The subordinate data is encrypted as necessary. In the recordable medium, the subordinate data is not only added before the contents data but also recorded into an area for data management on the medium 1. In case of a read only medium, the subordinate data is recorded into the data management area. If the medium is an optical disc, a management area as a data management area is generally provided for an area on the innermost rim side of the disc and the subordinate data is recorded into this management area. In case of the memory card, for example, file management data such that one music piece of the music data is handled as one file is specified.

The charge ID 131 is a charge identifier for indicating whether the contents is contents which needs the charging process upon reproduction or contents which is free upon reproduction. The charge conditions information 132 includes a reproducing conditions label for distinguishing the charge type such as buying type, gross type, degree type, or the like as mentioned above and instructing the charge conditions in each charge type. As an example of the reproducing conditions label, in case of the buying type, the data of the buying price of the contents is described on the reproducing conditions label. In case of limiting the number of reproducing times of the contents of the gross type, the data of the number of reproducing times of the contents is described on the reproducing conditions label. In case of limiting the reproducing period of the contents of the gross type, the data (1 day, 1 week, 1 month, etc.) of the reproducing period of the contents is described as a reproducing conditions label. In case of the degree type, data of the degree (¥1/2 minutes, ¥1/1 minute, ¥1/30 seconds, . . . ) is described as a reproducing conditions label. Further, even in case of the contents which is charged for as a prerequisite upon reproduction, the conditions in the case where the contents can be monitored free of charge can be also described on the reproducing conditions label.

Information indicative of the kind of compression encoding of the contents data, information indicative of the kind of encryption and parameters of the encryption, information indicative of the number of channels, information indicative of a bit rate, and the like can be also recorded in the subordinate data.

A media ID, for example, a serial number for enabling the media such as CD, MD, recordable optical disc, memory card including a non-volatile memory, and the like to be unconditionally identified is included in the subordinate data. A decoder ID is arranged in the subordinate data. The decoder ID is an ID, for example, a serial number for enabling a user's terminal and the secure decoder 202 built in the player 201 or the like of the user to be unconditionally identified.

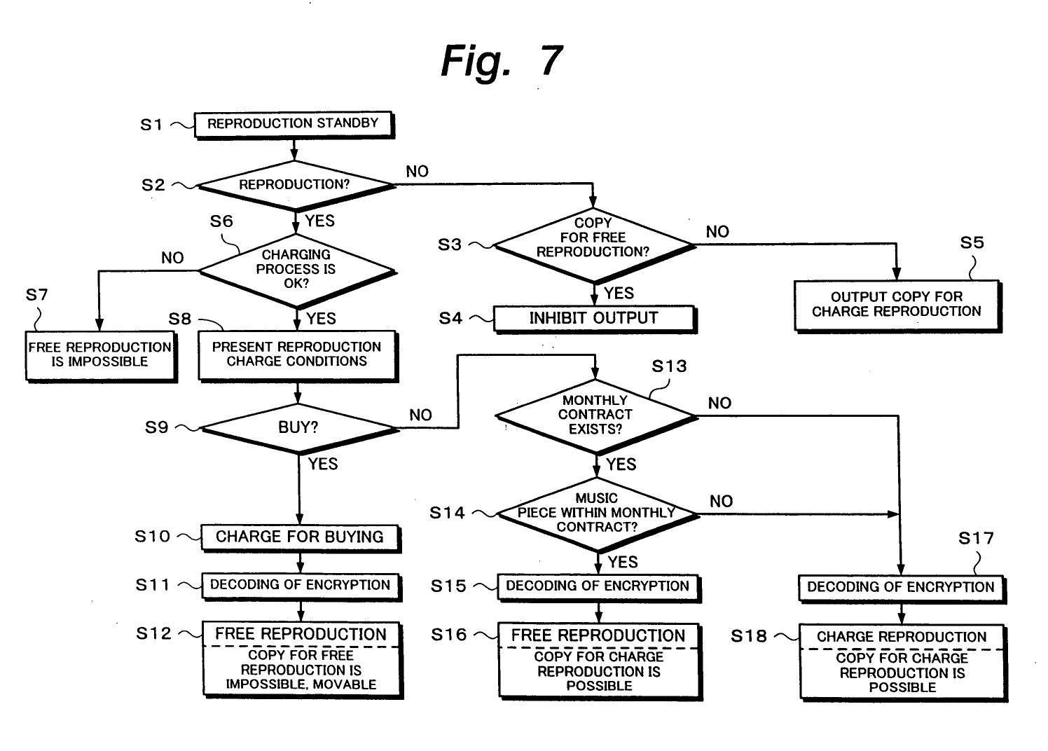

An example of the charging process which is executed in the player 201 (refer to FIG. 6) will now be described with reference to a flowchart of FIG. 7. This charging process is executed by the control unit 14 in the secure decoder 202 and the system controller 21. First step S1 indicates a reproduction standby mode in which contents designated by the user, that is, the contents to be reproduced exists in the medium 1. Specifically speaking, a case where the contents data distributed by the EMD has been stored in the medium 1, a case where the contents data has already been recorded in the medium 1, or the like corresponds to the reproduction standby. In step S2, the user depresses a play button of the operation unit 22, so that whether the reproduction has been instructed or not is discriminated.

If a result in step S2 indicates NO, it is decided that this means the copying operation of the contents and step S3 follows. In step S3, whether the contents for free reproduction is copied or not is discriminated. The contents for free reproduction denotes the contents which is not charged for upon reproduction of the contents. The discrimination in step S3 is made with reference to the charge identifier included in the subordinate data. If the contents to be reproduced is the contents for free reproduction in step S3, the copy output from the secure decoder 202 in which the encryption has been decoded is inhibited for the purpose of protection of the copyright (step S4).

If it is determined in step S3 that the contents to be reproduced is not the copy of the contents for free reproduction, that is, if it is decided in step S3 that it is the copy of the contents for charge reproduction, the copy data of the contents for charge reproduction is outputted from the secure decoder 202 (step S5). The contents for charge reproduction is freely copied. The copy data which is outputted from the secure decoder 202, however, is the subordinate data and the encrypted and compression encoded contents data.

If it is decided in step S2 that the reproducing operation has been instructed by the user, whether the charging process is permitted or not is inquired of the user in step S6. For example, a message indicative of the necessity of the charging process or the like is displayed onto the display 23 of the player 201, thereby promoting the user so as to answer by the operation of the operation unit 22 on the basis of the display on the display 23. If the user does not permit the charging process in step S6, the free reproduction of the contents cannot be performed (step S7). There is also a case where a situation such that the partial free reproduction, for example, the reproduction of the head portion or highlight portion of the music piece which is instructed by the reproducing conditions label of the subordinate data of the contents data is executed free of charge is permitted. If it is determined in step S6 that the user permits the charging process, the reproduction charge conditions regarding the contents to be reproduced at present are presented on the display 23 in step S8. The charge conditions are displayed on the display 23 on the basis of the information of the reproducing conditions label in the subordinate data.

In step S9, whether the charge type is the buying type or not is discriminated. If the charge type is the buying type, the charging process for buying is performed (step S10). In step S11, the encryption performed to the contents data is decoded in the decoder 11 of the secure decoder 202 by using the key data sent from the server 111. In step S12, the free reproduction of the contents is performed. In this case, the output of the copy data of the contents which is reproduced free of charge from the secure decoder 202 is inhibited. The moving process, that is, the process such that the original data does not remain unlike the copying process can be performed. For example, it is possible to perform a process such that after the contents data outputted from the player serving as a moving source was stored into the player serving as a movement destination, the moved contents data cannot be reproduced in the player serving as a moving source.

If it is determined in step S9 that the charge type is not the buying type, whether the charge type is the gross type, for example, the monthly contract type or not is determined in step S13. When it is decided in step S9 that the monthly contract exists, whether the music piece as contents to be reproduced is the contracted music piece or not is discriminated in step S14. If it is determined in step S14 that it is the contracted music piece, the contents is reproduced free of charge in step S15. The contents data for charge reproduction can be freely copied.

If it is decided in step S13 that the charge type is not the monthly contract type, it is determined that the contents to be reproduced is the contents which is charged for in the degree type. In step S17, the encryption performed to the contents data is decoded. In step S18, the charge reproduction is executed. In the charge reproduction, as mentioned above, the charging process is performed in accordance with the degree of reproduction of the contents, the reproducing time of the contents, and the like. The contents data for charge reproduction can be freely copied. Further, even if it is determined in step S14 that the contents to be reproduced does not lie in a range of the monthly contract, the charge reproducing process (step S17, step S18) is also performed.

In the embodiment of the invention, in the data charger 204 or secure decoder 202, ordinarily, when the listening right data 109 is purchased or received from the settlement center 110, the data regarding the reproduction log is transferred to the settlement center 110. In this case, there is a fear such that before the listening right data 109 is extinguished by the reproduction of the contents, the memory unit 16 or 24 in the player 201 in which the reproduction logs have been stored or a memory 309 in the charger 204 becomes full. Therefore, when the memory unit 24 or 16 or the memory unit 309 becomes full or when there is such a fear, a message for promoting the display 23 to transfer the reproduction logs is displayed or notified (alarm sound, beep sound, vibration, etc.) or the reproduction log is transferred, thereby preventing an overflow of the memory unit 16 or 24 or the memory unit 309. Until the transfer of the reproduction log or the transfer from the secure decoder 202 in the player 201 to the charger 204 is finished, the controller 21 of the player 201 inhibits the reproduction of the contents by the secure decoder 202. Until the transfer of the reproduction log to the settlement center 110 is finished, in the secure decoder 204, the writing of the reproduction log from the player 201 into the memory unit 309 is inhibited by the CPU 301.

For example, if it is necessary to collect the reproduction logs once a month in order to perform the settlement, when a preset date comes, a message to promote the transfer of the reproduction log is displayed onto, for example, the display 23 of the player 201 or notified (alarm sound, beep sound, vibration, etc.), or the reproduction log is transferred to the settlement center 110, thereby preventing the overflow of the memory unit 24 in the player 201 or the memory unit 16 in the secure decoder 202.

Further, like a state where the player 201 and data charger 204 are always connected to a telephone line, when an on-line state with the settlement center 110 can be automatically set, the reproduction log is automatically transferred to the settlement center without promoting the user to transfer. While the reproduction log is transferred, to eliminate the necessity of storing a new reproduction log into the memory unit 24 or 16, the player 201 is locked so that it cannot receive the listening right data 109. The user operates the operation unit 22 in accordance with a display guide displayed on the display 23 of the player 201 and transfers only the reproduction log to the settlement center 110 or data charger 204 without transmitting or receiving the listening right data 109. After completion of the transfer of the reproduction log, the lock which disables the transmission and reception of the listening right data by the player 201 is released.

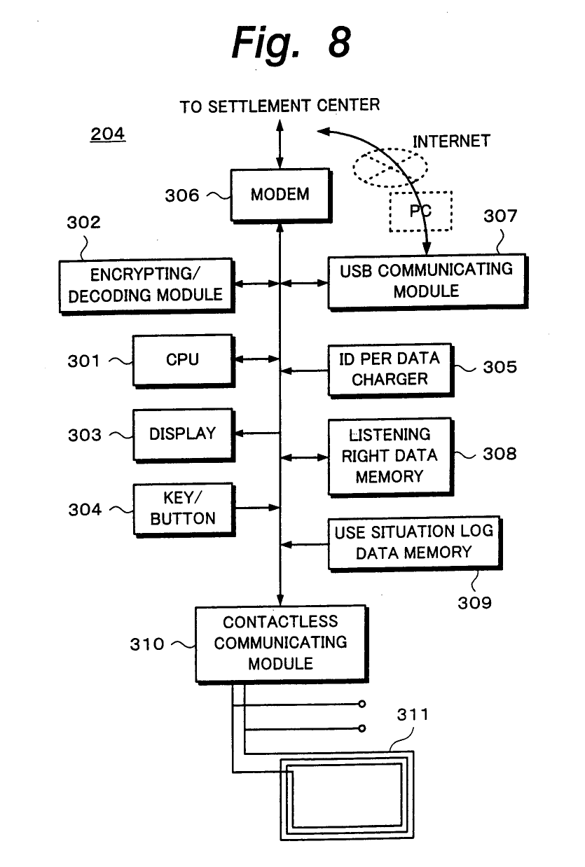

The foregoing embodiment of the invention will be described in more detail. FIG. 8 shows a construction of an example of the data charger 204. The charger 204 is constructed, for example, as a portable terminal apparatus which can be carried. Reference numeral 301 denotes the CPU for controlling the whole charger 204; 302 an encrypting/decoding module; 303 a display (for example, liquid crystal display); and 304 a plurality of keys/buttons which are operated by the user. A menu, charge processing conditions, and the like regarding the operation of the charger 204 are displayed on the display 303. The encrypting/decoding module 302 executes the encrypting process to the reproduction log upon transmission of the reproduction log or the like and the decoding process of the encryption of the listening right data upon reception of the listening right data or the like. Reference numeral 305 denotes an ID per data charger. The ID 305 per data charger is transmitted to the settlement center 110, for example, together with the reproduction log, thereby enabling a correspondence relation between the data charger 204 and the reproduction log to be known.

A modem 306 and a USB (Universal Serial Bus) communicating module 307 are provided for the data charger 204 for the purpose of communicating with the settlement center, for example, the settlement center 110 in FIG. 2. The data charger 204 communicates with the settlement center 110 through the telephone line by the modem 306, receives the listening right data 109 from the settlement center 110, and can transmit the reproduction log to the settlement center 110. It is possible to similarly communicate with the settlement center 110 by using the USB communicating module 307 by the personal computer and the Internet.

The listening right data 109 received from the settlement center 110 by the data charger 204 is stored into a listening right data memory 308. The reproduction log received from the secure decoder 202 of the player 201 is stored into the use situation memory 309 of the data-charger 204. Log data obtained by adding the log of the charger 204 to the reproduction log extracted from the player 201 is transmitted to the settlement center 110 as necessary. The memories 308 and 309 are non-volatile memories such that the storage contents are held even if the power source of the data charger 204 is turned off.

A contactless communicating module 310 and an antenna 311 are used for communicating with the player 201 in a contactless manner. The communication which is executed between the player 201 and data charger 204 is performed by using an encrypted protocol under a condition that the authentication is mutually performed between the player 201 and charger 204. Not only the data but also an electric power necessary for making the secure decoder 202 operative can be transmitted from the data charger 204 to the player 201. Therefore, even if the main power source of the player 201 is OFF, the data charger 204 can transmit and receive the listening right data and the reproduction log to/from the secure decoder 202. Besides the antenna 311, the data charger 204 also has a terminal for line connection. The data charger 204 communicates with the listening right data sales terminal 206 by using the contactless communicating module 310 and antenna 311 or lines.

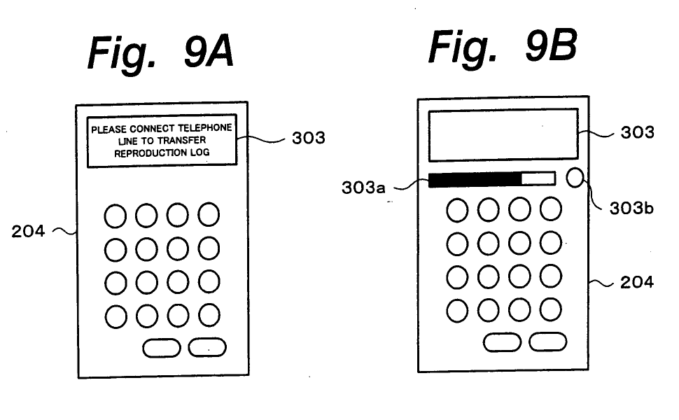

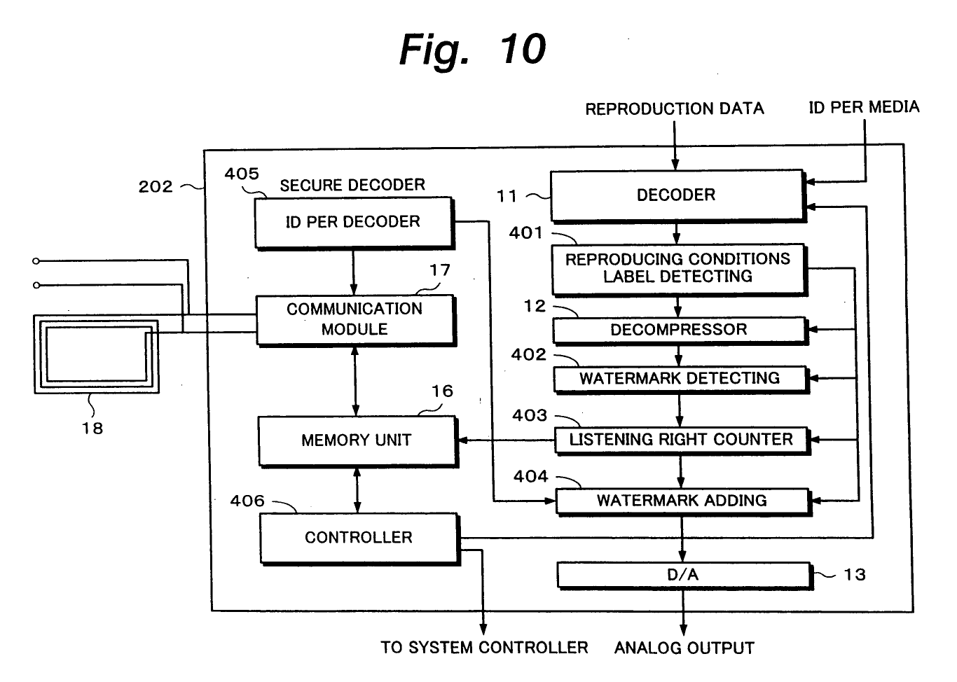

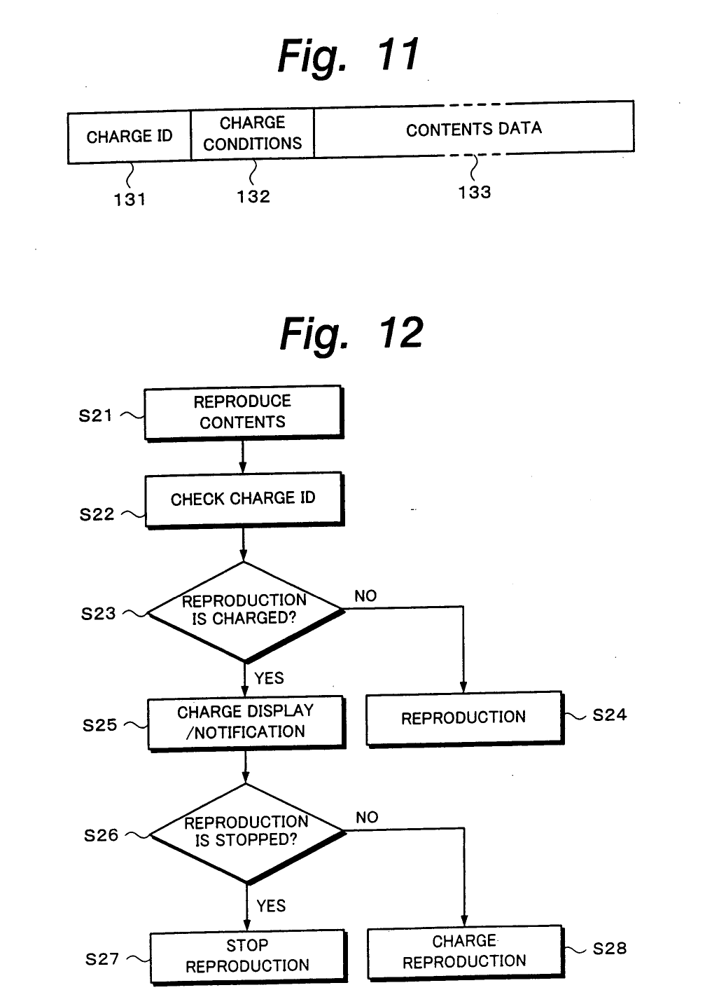

In the foregoing data charger 204, a remaining amount of the memory capacity or a use amount of the memory capacity of the use situation log data memory 309 are monitored by the CPU 301. For example, when the remaining amount is equal to 10%, as shown in FIG. 9A, a message for promoting the transfer of the reproduction log is displayed on the display unit 303 of the charger 204 by the CPU 301. For example, a message “Connect the telephone line for transfer of reproduction log” is displayed on the display unit 303. An alarm sound, voice, or vibration can be also generated in place of displaying onto the display unit 303 or together with the display. When the user connects the charger 204 to the telephone line in response to the display, it is sensed and the user transfers the reproduction log to the settlement center 110 with reference to the display on the display unit 303 or automatically transfers it. Actually, to eliminate the necessity of the storage of the new reproduction log into the memory 309 while the reproduction log is transferred to the settlement center 110, the charge for the listening right data into the data charger 204 is inhibited.

As shown in FIG. 9B, a display unit 303a for displaying a remaining amount of the memory capacity of the use situation log data memory 309 or a use amount of the memory capacity by the CPU 301 can be also provided for the charger 204. In the display unit 303a, a length of a bar-shaped display changes in accordance with the remaining amount in which data can be stored in the memory 309 or the use amount of the memory 309. Further, a warning lamp 303b which is lit on or flickers when the foregoing remaining amount or use amount in the memory 309 reaches a predetermined value can be also provided. Naturally, the display unit 303a and warning lamp 303b can be also displayed on the display unit 303 instead of being separately provided from the display unit 303.

It is also possible to construct in a manner such that the charger 204 has a calendar and, as mentioned above, when it is detected by the calendar that a preset date has come, for example, the display 303 is warned to transfer the reproduction log, thereby allowing the user to transmit the reproduction log to the settlement center or allowing the reproduction log to be automatically transferred.

FIG. 10 shows a more detailed construction of the secure decoder 202, that is, a functional construction regarding the charging process. Portions corresponding to the component elements shown in FIG. 6 are designated by the same reference numerals. The data which was readout from the medium 1 and comprises the compression encoded contents data and subordinate data is supplied to the decoder 11. An ID per media for enabling the medium 1 to be unconditionally discriminated is also supplied to the decoder 11 together with the foregoing contents data and subordinate data. The encryption performed to the contents data and subordinate data is decoded by the decoder 11.

Output data of the decoder 11 is supplied to a reproducing conditions label detecting unit 401. A reproducing conditions label in the subordinate data is detected by the detecting unit 401. The reproducing conditions label detected by the detecting unit 401 is used for the process by the secure decoder 202. In the decompressor 12, the compression encoding performed to the contents data whose encryption has been decoded by the decoder 11 is decoded. Output data of the decompressor 12 is supplied to a watermark detecting unit 402. The watermark detecting unit 402 detects the added watermark before the contents data is converted into the analog signal and outputted as will be described hereinlater, and discriminates whether the reproducing conditions label has been falsified or not on the basis of the detected watermark and the reproducing conditions label detected by the detecting unit 401.

Reference numeral 403 denotes a listening right counter. In the listening right counter 403, the listening right data 109 is changed each time the contents data is decoded. For example, the listening right counter 403 executes a process for subtracting the listening right data 109 stored in the memory unit 16, for example, the degree data. The listening right data 109 which is stored in the memory unit 16 is the data transmitted from the foregoing data charger 204 by the antenna 18 (or line) and communicating module 17. A module for encryption upon transmission of the reproduction log or the like and a module for decoding the encryption performed to the listening right data 109 upon reception of the listening right data 109 are provided in the communicating module 17. Although a terminology “listening right” has been used in the invention for the purpose of handling the music piece data, when considering while including the video data, a terminology “monitoring right” is used in place of the listening right.

In the listening right counter 403, when the processes regarding the listening right in association with the decoding of the contents data are executed, the watermark is added to the output data by a watermark adding unit 404. As a watermark which is added by the adding unit 404, the watermark can be added by using a redundant portion existing in the music piece data, for example, lower bits of audio data which is outputted. As mentioned above, even if the audio data is converted into an analog signal, the watermark added to the lower bits of the audio data remains in the analog signal, and the watermark cannot be removed from the analog signal or it is very difficult to remove the watermark. The watermark added by the adding unit 404 includes the whole reproducing conditions label or partial data and information of an ID 405 per decoder. The data to which the watermark has been added is converted into an analog signal by the D/A converter 13 and outputted to the outside of the secure decoder 202. The foregoing watermark detecting unit 402 detects the watermark added by the adding unit 404. Reference numeral 406 denotes a controller for controlling the whole secure decoder 202 and communicating with the system controller 21 of the player 201 or the like.

It is also possible to construct the apparatus in a manner such that the secure decoder 202 has an interface of an IC card and the data charger 204 receives the electronic money from the settlement center or a financial company and writes the received electronic money into the IC card through the interface provided for the secure decoder 202. That is, it is possible to allow the secure decoder 202 to have a function as a recording apparatus of electronic money as an optional function in response to the writing of the listening right data.

An outline of the charging process which is executed by the listening right counter 403 will now be described. For instance, an example which is applied to the case where the charging process is executed by the degree type will be explained. That is, the degree is subtracted from the preset degree each time the reproducing process of the music piece data as contents data is executed, the degree is added each time there producing process of the music piece data is executed, or the degree is added or subtracted in accordance with the reproducing time of the music piece data. The reproducing conditions label detecting unit 401 extracts the reproducing conditions label from the subordinate data read out from the medium together with the contents data. The charge conditions are included in the reproducing conditions label. For example, when the label shows that the charging process is executed in accordance with the reproducing time, a period of time during which the music piece data is outputted from the decompressor 12 is measured by a unit time such as 30 seconds, 1 minute, or the like and the reproduction is charged for with respect to the measured duration of time. That is, in case of executing the charging process on the basis of the reproducing time, the unit time is made to correspond to one degree.

The degree is controlled by the listening right counter 403 on the basis of the measured time and the reproducing conditions label. That is, with reference to the reproducing conditions label, the counter 403 executes the subtracting or adding process to the listening right data 109 stored in the memory unit 16 and rewrites the listening right data 109 in the memory unit 16. In case of using the reproducing time or reproducing period as a reproducing condition, for example, an accumulating process of the reproducing time or a collating process between the present date/time and the reproduction possible term is executed with respect to the timer/calendar built in the counter 403.

The listening right counter 403 or controller 406 further discriminates whether the contents can be reproduced or not on the basis of the remaining amount of the listening right data. For example, when the reproduced degree is subtracted from the listening right data and the remaining degree reaches “0”, it is determined that the reproduction of the contents is impossible. If the accumulation degree of the listening right data reaches the set degree, the accumulated reproducing time reaches the set time, or the present date/time at which it is intended to reproduce the contents exceeds the reproducing term of the contents, it is determined that the reproduction of the contents is impossible in a manner similar to the foregoing case. If the reproduction of the contents is possible, the music piece data is converted into the analog signal and outputted from the secure decoder 202. On the other hand, if the reproduction of the contents is impossible, the output of the music piece data from the secure decoder 202 is inhibited.

In the foregoing secure decoder 202, the controller 406 monitors the remaining amount of the memory capacity allocated for storage of the reproduction log in the memory unit 16 or the use amount of the memory capacity. In a manner similar to the case of the data charger 204, when the memory capacity allocated for storage of the reproduction log in the memory unit 16 reaches a preset value or the set date comes, a display, notification, or the like of a message for promoting the data charger 204 to transfer the reproduction log is performed onto the display 23 of the player 201. The reproduction log is automatically transferred to the data charger 204 in dependence on the construction of the system of the player 201.

To eliminate the necessity of the storage of the new reproduction log into the memory unit 16 while the reproduction log is actually transferred to the data charger 204, the controller 406 controls the decoder 11 or a gate circuit (not shown), thereby locking so as to substantially inhibit the decoding of the contents data which is executed by the decoder 11 or the reproduction of the contents. Thus, it is possible to prevent the occurrence of a situation such that the history of the decoding or reproduction is not reflected to the reproduction log. The locking of the decoder 11 is released after the end of the transfer of the reproduction log data to the data charger 204.

An example of processes which are executed in the player 201 according to another embodiment of the invention will now be described with reference to a flowchart of FIG. 12. The processes are executed by the control unit 14 in the secure decoder 202 and the system controller 21. First step S21 relates to a case where an instruction to reproduce the contents is generated. For example, it relates to a case where the contents to be reproduced (that is, selected by the user) exists in the medium 1 and the user instructs the reproduction by depressing a play button of the operation unit 22.

In step S22, the charge ID 131 in the subordinate data is discriminated. On the basis of a result of the discrimination of the charge ID 131, whether the contents to be reproduced is charged for upon reproduction or not is discriminated in step S23. If the contents to be reproduced is contents which is free upon reproduction in step S23, step S24 follows and the contents selected by the user is reproduced. If the contents to be reproduced is contents which is charged for upon reproduction in step S3, step S25 follows and a message indicating that the user is charged for upon reproduction of the contents is displayed or warned onto the display 23. A specific example of the display or warning will be explained hereinlater.

After step S25, whether the reproduction of the contents is stopped or not is discriminated in step S26. By the display/notification in step S25, the user can know that the contents to be reproduced is contents which needs the charging upon reproduction. Subsequently, the user determines whether he reproduces the contents or not. If the operation unit 22 is operated by the user and the reproducing process is stopped in step S26, the reproducing process of the contents is stopped in step S27. In case of continuing the reproducing process of the contents in step S26, the contents as a charge target is reproduced in step S28. That is, the encryption performed to the contents data is decoded by the decoder 11 of the secure decoder 202, and the compression encoding of the contents data whose encryption has been decoded is decoded by the decompressor 12. At this time, the listening right data 109 in the memory unit 16 is changed, for example, the degree is subtracted by “1” on the basis of the charge conditions information 132 in the subordinate data.

Although the processes in FIG. 12 have been described with respect to the reproduction of the contents, also in case of downloading the contents into a personal computer or the like through the network, in a manner similar to that mentioned above, the discrimination about whether the contents to be downloaded is contents which needs the charge upon reproduction or free contents and the display/notification based on a result of the discrimination are performed to the user by using the display or the like.

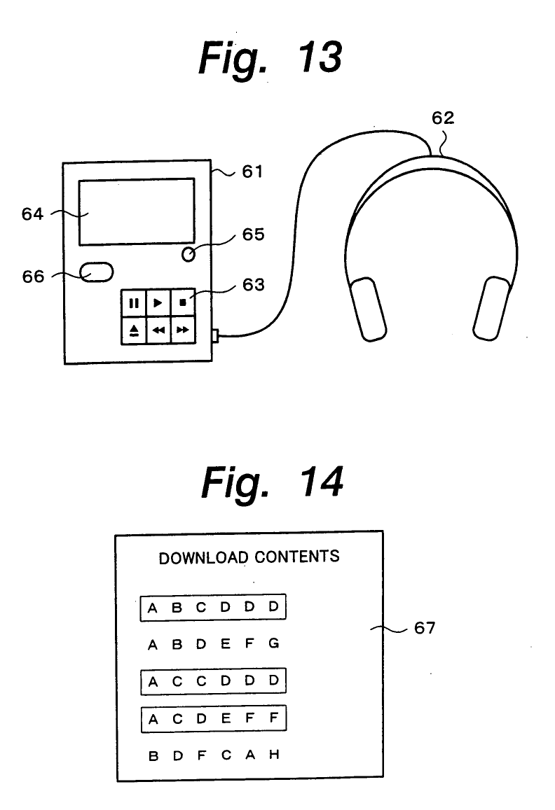

In order to display a message showing that the contents to be decoded, reproduced, or obtained is charged for upon reproduction or notify the user of such a message, a method of enabling such a message to be understood visually, audibly, or by a vibration is used. FIG. 13 is a diagram for describing a displaying/notifying method in a portable audio player (or recorder). Reference numeral 61 denotes a whole player using a medium such as CD, MD, memory card, or the like. A headphone or ear receiver 62 is connected to the player 61, an operation switch 63 is provided, and further, a display unit 64 for displaying the operating mode, time, music piece name, and the like is provided.

In such a player 61, to display that the contents to be reproduced is contents which is charged for, the display unit 64 is displayed brightly as a whole (light-up). A charge lamp 65 which emits a light for a period of time during which the contents to be charged is reproduced is provided. By the charge lamp 65, the user can certainly know the charging state. By generating a beep sound through the ear receiver 62, for example, the user can be also notified of a fact that the contents is the contents which is charged for before the start of the reproduction of the contents.

In FIG. 13, reference numeral 66 denotes a charge lock switch. When the charge lock switch 66 is depressed by the user, the reproduction of the contents which is charged is inhibited. When the switch 66 is released, the contents can be decoded or reproduced without discriminating whether the contents to be reproduced is the contents which is charged for or the free contents. In the case where the charge type is the monthly contract type, it is also possible to construct the apparatus in a manner such that the user can always decode or reproduce the contents for a month or period of time during which the free reproduction is permitted. For example, when the control unit of the player 61 determines that the contents data to be reproduced when the switch 66 is depressed is the contents which needs the charge on the basis of the charge ID 131 of the subordinate data, the reproduction of the contents is inhibited.

The control of the display/notification in the portable player 61 mentioned above is made by the system controller 21 in case of the player 201 in FIG. 6. That is, the system controller 21 receives the charge ID 131 and charge conditions information 132 from the secure decoder 202 and the system controller 21 controls the display unit 23 on the basis of the received charge ID 131 and charge conditions information 132, so that the control of the display mentioned above can be made. The foregoing charge lock switch 66 is provided for the operation unit 22 of the player 201 shown in FIG. 6. Thus, the player 201 can also inhibit the reproduction of the contents which is charged upon reproduction in a manner similar to the player 61.

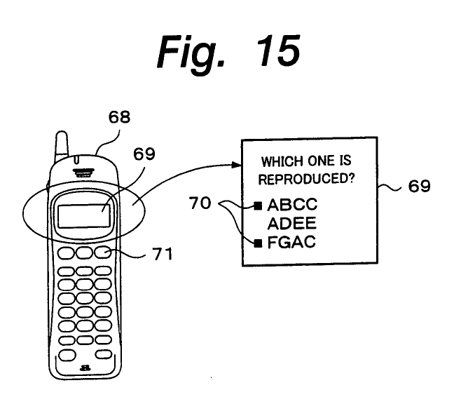

FIG. 14 shows a display example in case of downloading contents into a personal computer through a communication medium, for example, the Internet. In FIG. 14, a list of names of music pieces which can be downloaded is displayed in a homepage which is displayed on the screen of a display unit 67. In the list on the display unit 67, it is shown that the music piece names surrounded by frames indicate music pieces as contents which is charged upon reproduction. By looking at the list on the display unit 67, the user can download desired music pieces and can download them into, for example, the player 61 shown in FIG. 13 while being conscious of whether the decoding or reproduction is charged for or free. In this case, the music pieces as downloaded contents are temporarily stored into a hard disk of the personal computer and, thereafter, the downloaded music pieces are moved to a terminal such as a player 61 or the like by a moving process or the like.

In FIG. 15, reference numeral 68 denotes a cellular phone and 69 indicates its display unit. For example, in a situation such that the music distributing system shown in FIGS. 1 and 2 is constructed, the distributed music data can be downloaded into a semiconductor memory, a memory card, or the like built in the cellular phone 68. In this case, a list of names of music pieces which can be downloaded as enlargedly shown in FIG. 15 is displayed onto the display unit 69. In this list, a mark 70 in a square shape or the like is added to the name of the music piece which is charged for upon decoding or reproduction. Thus, the user can easily know whether the selected music piece is a music piece which is charged for upon reproduction or not. It is also possible to construct in a manner such that when the user selects the downloading of the music piece which is charged for upon reproduction, a vibration is generated to thereby inform the user of it by using a vibrating function which the cellular phone 68 has. In a manner similar to the case mentioned above, the controller of the cellular phone 68 discriminates it on the basis of the charge ID 131 in the subordinate data and the cellular phone vibrates in case of the music piece whose charge is necessary upon reproduction on the basis of a result of the discrimination.

Further, a mode change-over button 71 is provided for the cellular phone 68. The mode change-over button 71 switches a selection reference about the name of the music piece to be downloaded. For example, a charge locking mode, a charge A mode, and a charge B mode are prepared as selection references which are switched by the button 71. The charge locking mode is a mode in which only the free contents can be downloaded (in other words, a mode in which the contents which is charged upon reproduction is refused). In the charge A mode and charge B mode, the music pieces which can be downloaded are selected in accordance with an amount of fee which is charged for upon reproduction. For example, the charge A mode is a mode in which only the contents whose fee that is charged upon reproduction is relatively cheap can be downloaded. The charge B mode is a mode in which all of the contents can be downloaded irrespective of whether the charge is necessary or free upon reproduction. The fee which is charged for upon reproduction is included in the charge conditions information 132 in the data configuration shown in FIG. 5. For example, when the charge locking mode is selected by the button 71, the control unit of the cellular phone 68 discriminates the charge ID 131 in the subordinate data of the contents data, downloads only the contents data which is free upon reproduction, and writes it into the memory or the like. When the charge A mode or charge B mode is set, the charge ID 131 indicates that the reproduction is charged for, the charge conditions information 132 is analyzed, and the contents data which satisfies the charge conditions set by the user is downloaded.

Although the above embodiment has been described mainly with respect to the audio contents, the invention can be also applied to contents such as video data, still image data, character data, computer graphics data, game software, computer program, etc. other than the audio data in a manner similar to that mentioned above.

As will be obviously understood from the above description, according to the invention, the overflow of the memory for storing the use history information is prevented, the use history information can be certainly transferred, and the use history information can be corrected.

1. A digital data processing method which is used for one of a medium and a network in which first digital data having one of a signal and a reproduction charged for and second digital data having one of a decoding and a reproduction not charged for exist concurrently, comprising the steps of:
determining whether distributed digital data is one of the first and the second digital data when the distributed digital data are one of decoded, reproduced, and obtained; and
inhibiting one of the decoding, the reproduction, and the obtaining of the first digital data.

2. The digital data processing method according to claim 1, wherein the determination is made based on an identifier added to the first digital data.

3. The digital data processing method according to claim 1, wherein the determination is made one of before, simultaneously with, and after one of the decoding, the reproduction, and the obtaining.

4. The digital data processing method according to claim 1, wherein
an identifier indicating one of a presence and an absence of a charge and information of a fee have been added to the first digital data; and
when the distributed digital data is the first digital data a threshold value regarding whether the notification is performed is set for the fee.

5. The digital data processing method according to claim 1, wherein the notification is performed one of visually, audibly, and by one of a presence and an absence of a vibration.

6. The digital data processing method according to claim 1, wherein the first and second digital data are one of audio data, video data, still image data, character data, computer graphics data, game software, and a computer program.

7. The digital data processing method according to claim 1, wherein the first and second digital data are distributed by using one of a satellite broadcast, a ground wave broadcast, an Internet, a cable television broadcast, a cellular phone, a PHS, and a package media.

8. A digital data processing apparatus used for one of a medium and a network in which first digital data having one of decoding and reproduction charged for and second digital data having one of decoding and reproduction is not charged for exist concurrently, comprising:
determining means for determining whether distributed digital data are one of the first and the second digital data when the distributed digital data are one of decoded, reproduced, and obtained; and
inhibiting means for inhibiting one of the decoding, the reproduction, and the obtaining of the first digital data when the determining means determines that the distributed digital data are the first digital data.

9. The digital data processing apparatus according to claim 8, wherein
an identifier indicating one of a presence and an absence of a charge and information of a fee have been added to the first digital data; and
when the distributed digital data are the first digital data a threshold value for the fee is set and when the fee is one of equal to and larger than a predetermined value one of the decoding, the reproduction, and the obtaining of the first digital data is inhibited.

10. The digital data processing apparatus according to claim 8, further comprising selecting means for selecting one of a mode to validate a function for inhibiting one of the decoding, the reproduction, and the obtaining of the first digital data and a mode to invalidate the function.
